(19) United States
(12) Patent Application Publication
(10) Pub. No.: US 2004/0036709 A1
(43) Pub. Date: Feb. 26, 2004

(54) System, method, and computer program product in a data processing system for registering with a service utilizing a graphical depiction of a process definition

(75) Inventors: Virgil A. Albaugh, Austin, TX (US); Messaoud Benantar, Austin, TX (US); Philip Yen-tang Chang, Austin, TX (US); Hari Haranath Madduri, Austin, TX (US)

Correspondence Address: Duke W. Yee, Carstens, Yee & Cahoon, LLP, P.O. Box 802334, Dallas, TX, 75380, US

(73) Assignee: IBM Corporation, Armonk, NY

(21) Appl. No.: 10/226,966

(22) Filed: Aug. 22, 2002

(51) Int. Cl. G09G 5/00

(52) U.S. Cl. 345/700; 345/764

(57) ABSTRACT

A system, method, and computer program product are disclosed for registering with a service provided by a processing node. A process definition is generated. The process definition includes a particular sequence of selected services that are provided by processing nodes. The process definition is then graphically depicted to a user. A graphical selection of any one of the processing nodes is permitted utilizing the graphical depiction. In response to a receipt of a selection of one of the processing nodes, a registration form is providing by the processing node. Registration information is then received by the processing node through the registration form. Thus, registration is completed directly with the processing node.

### CROSS-REFERENCE TO RELATED APPLICATIONS

The subject matter of the present invention is related to copending United States application, attorney docket number AUS920020121US1, Ser. No. ______, titled “System, Method, and Computer Program Product in a Data Processing System for Defining a Process by Graphically Guiding an Example Input Through Selected Processing Nodes”, filed on the same date herewith, assigned to the same assignee, and incorporated herein by reference.

### BACKGROUND OF THE INVENTION

1. Technical Field

The present invention relates generally to the field of data processing systems and, more specifically to a system, method, and computer program product in a data processing system for registering with a service provided by a processing node utilizing a graphical depiction of a process definition.

2. Description of Related Art

Systems are known which include a set of processing nodes, each providing a particular service. These processing nodes may be collected in one centralized location called a service bureau. Each service may be provided by an entity that is separate and independent from the entities that provide the other services. For example, a first company might provide a first service, while a second separate and independent company might provide a second service. The service bureau is a central location where these services may be selected.

A user may view and select services that are provided by a service bureau. A problem arises with these service bureaus, however when a user attempts to select particular services. When a user wishes to select one or more services offered by the bureau, the service bureau sequentially presents to the user each available service in a predetermined order. If the user is interested in a service, the user may select that service. The next service in the predefined order is then presented to the user.

The customer must register with each service individually prior to using the service. The user may not register with these services through the service bureau. The user must contact each service separately and apart from the service bureau to provide the information that is necessary in order to use the service. Known service bureaus do not permit a user to register with the services through the service bureau because each service may offer different options depending on the user's answers to some of the registration questions.

Therefore, a need exists for a method, system, and computer program product for registering with a service through a service bureau which provides the service utilizing a graphical depiction of a process definition.

### SUMMARY OF THE INVENTION

A system, method, and computer program product are disclosed for registering with a service provided by a processing node. A process definition is generated. The process definition includes a particular sequence of selected services that are provided by processing nodes. The process definition is then graphically depicted to a user. A graphical selection of any one of the processing nodes is permitted utilizing the graphical depiction. In response to a receipt of a selection of one of the processing nodes, a registration form is providing by the processing node. Registration information is then received by the processing node through the registration form. Thus, registration is completed directly with the processing node.

The above as well as additional objectives, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation which depicts a data processing system in accordance with the present invention;

FIG. 2 illustrates a block diagram of a computer system which may be utilized as a server computer system in accordance with the present invention;

FIG. 3 depicts a block diagram of a computer system which may be utilized as a client computer system in accordance with the present invention;

FIG. 4 is a pictorial representation of a display screen on which is depicted a graphical representation of processing nodes in accordance with the present invention;

FIG. 5 is a pictorial representation of a display screen on which is illustrated a graphical representation of a process definition in accordance with the present invention;

FIG. 6 is a pictorial representation of a display screen on which is depicted a registration form for a translator processing node in accordance with the present invention;

FIG. 7 is a pictorial representation of a display screen on which is illustrated a registration form for a transmitter processing node in accordance with the present invention;

FIG. 8 depicts a high level flow chart which illustrates a service bureau graphically guiding registration with selected processing nodes utilizing a graphically displayed process definition in accordance with the present invention; and

FIG. 9 illustrates a high level flow chart which depicts a processing node providing a registration form and storing registration information locally in the processing node in accordance with the present invention.

### DETAILED DESCRIPTION OF THE PREFERRED EMBODIMENT

A preferred embodiment of the present invention and its advantages are better understood by referring to the figures, like numerals being used for like and corresponding parts of the accompanying figures.

The present invention is a system, method, and computer program product for registering with a service provided by a processing node.

A service bureau provides a graphical depiction of its services that are provided by processing nodes. A user may graphically select ones of these services in a particular sequence in order to generate a process definition. The process definition is a particular sequence of selected services. Each service is provided by one or more of the processing nodes.

The process definition is then graphically depicted and displayed to a user by the service bureau. A graphical selection of any one of the processing nodes is permitted using the graphical depiction. The user need not step through a predetermined sequential list of available services. The user may go directly to the service with which the user wishes to register.

In response to a receipt of a selection of one of the services provided by a processing node, a registration form is provided by that processing node. Registration information is then received by the processing node through the registration form. In this manner, the user may register directly with any processing node. In addition, each processing node may determine independently from other processing nodes what type of user-profile information is needed in order to register with the processing node. A processing node stores all of its registration information locally within the processing node. In this manner, services may be added or removed from the service bureau without affecting the stored registrations.

Each processing node may be a different business entity. Thus, the services provided by the processing nodes may be provided by different business entities. These business entities are typically unrelated.

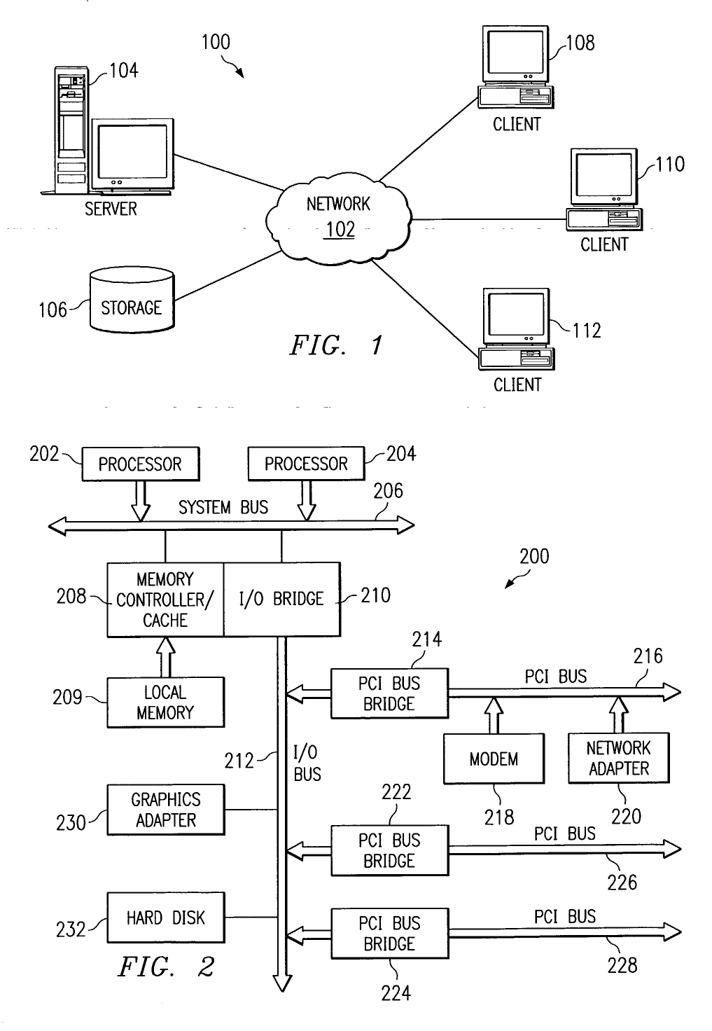

FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, a server 104 is connected to network 102 along with storage unit 106. In addition, clients 108, 110, and 112 also are connected to network 102. Network 102 may include permanent connections, such as wire or fiber optic cables, or temporary connections made through telephone connections. The communications network 102 also can include other public and/or private wide area networks, local area networks, wireless networks, data communication networks or connections, intranets, routers, satellite links, microwave links, cellular or telephone networks, radio links, fiber optic transmission lines, ISDN lines, T1 lines, DSL, etc. In some embodiments, a user device may be connected directly to a server 104 without departing from the scope of the present invention. Moreover, as used herein, communications include those enabled by wired or wireless technology.

Clients 108, 110, and 112 may be, for example, personal computers, portable computers, mobile or fixed user stations, workstations, network terminals or servers, cellular telephones, kiosks, dumb terminals, personal digital assistants, two-way pagers, smart phones, information appliances, or network computers. For purposes of this application, a network computer is any computer, coupled to a network, which receives a program or other application from another computer coupled to the network.

In the depicted example, server 104 provides data, such as boot files, operating system images, and applications to clients 108-112. Clients 108, 110, and 112 are clients to server 104. Network data processing system 100 may include additional servers, clients, and other devices not shown. In the depicted example, network data processing system 100 is the Internet with network 102 representing a worldwide collection of networks and gateways that use the TCP/IP suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/O bus 212 provides an interface to PCI local bus 216. A number of modems may be connected to PCI bus 216. Typical PCI bus implementations will support four PCI expansion slots or add-in connectors. Communications links to network computers 108-112 in FIG. 1 may be provided through modem 218 and network adapter 220 connected to PCI local bus 216 through add-in boards.

Additional PCI bus bridges 222 and 224 provide interfaces for additional PCI buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM RISC/System 6000 system, a product of International Business Machines Corporation in Armonk, N.Y., running the Advanced Interactive Executive (AIX) operating system.

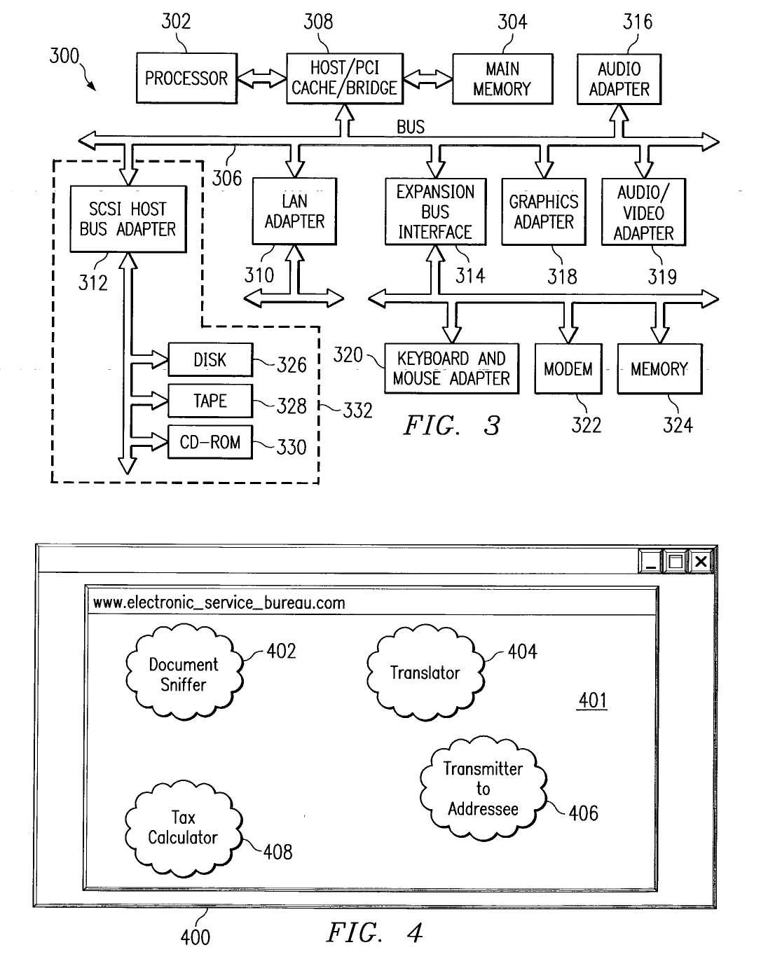

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, SCSI host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. Small computer system interface (SCSI) host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows 2000, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash ROM (or equivalent nonvolatile memory) or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interface, whether or not data processing system 300 comprises some type of network communication interface. As a further example, data processing system 300 may be a Personal Digital Assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance.

FIG. 4 is a pictorial representation of a display screen 400 on which is depicted a graphical representation of processing nodes in accordance with the present invention. Processing nodes 402, 404, 406, and 408 are graphically depicted to a user utilizing display screen 400. These processing nodes may be depicted using an Internet page 401.

Processing node 402 is depicted as a document sniffer service. This service receives as its input a document of an unknown type. This service then determines and displays the type of document. Processing node 404 is illustrated as a translator service. This service is capable of receiving as its input a document having a first type and translating that document to generate an output where the document now has a second type.

Processing node 406 is depicted as a transmitter service whereby documents input to the transmitter service are transmitted to another computer system. Processing node 408 is illustrated as a tax calculator service whereby tax is calculated for input transactions.

These various processing nodes 402, 404, 406, and 408 together make up an electronic service bureau. The electronic service bureau manages window 401. An electronic service bureau is a centralized collection of services that may or may not be provided by unrelated, different business entities. The services are centralized in that they are presented to a user from a central location, such as through an Internet page. An electronic service bureau may also be called an electronic hub, or ehub. Other processing nodes that perform various other types of services may also be included. Further, other processing nodes that provide a service that is the same or similar to the depicted processing nodes may be included.

One or more of these services may be performed by different computer systems. Further, the services that these nodes represent may be provided by unrelated business organizations. For example, a first business may provide translator node 404 which is executed by that business's computer system which may be located in a particular geographical area. A second business may provide tax calculator node 408 which is executed by the second business's computer system which may be located in a different geographical area. As an example, Business A, located in New York, may provide translator service 404, while Business B, located in California, may provide tax calculator 408.

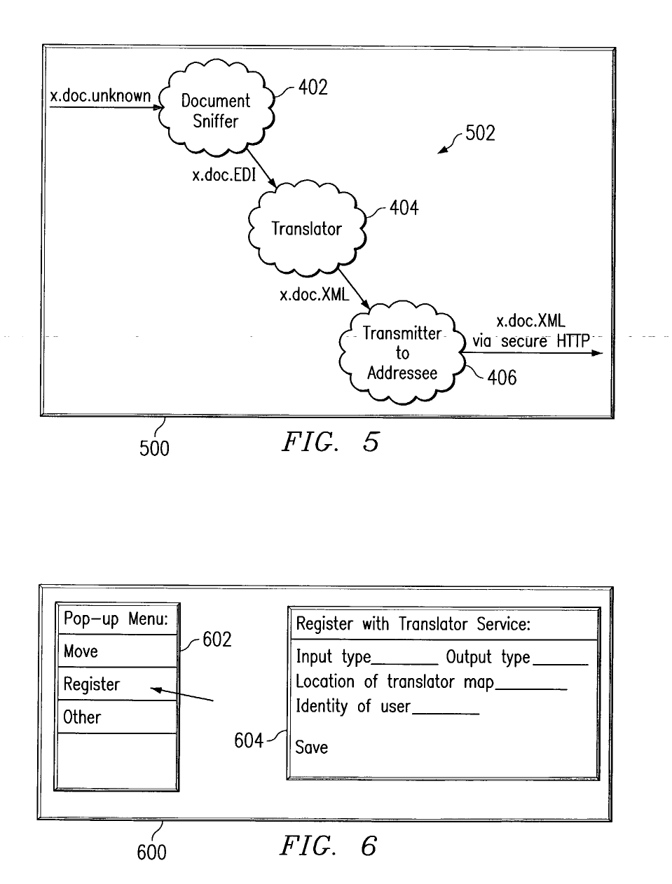

FIG. 5 is a pictorial representation of a display screen 500 on which is illustrated a graphical representation 502 of a process definition in accordance with the present invention. The process definition includes a first step of receiving a document having an unknown type within a document sniffer service, represented by icon 402. If the document sniffer service determines that the document is an EDI document, the document will be input into the translator service, represented by icon 404. The translator service then translates the document to an XML type document. This XML document is then sent to the transmitter service, represented by icon 406 which then transmits the document via secure HTTP.

The process definition 502 is graphically displayed to a user. In order to be able to execute the process, a user must first register with each service included in the process definition. The user may select any icon in order to register with the processing node's service represented by that icon. The user may register with the services in any order. When the user selects an icon, the user is able to register directly with the service represented by the selected icon.

For example, the user may choose to first register with the translator service graphically represented utilizing icon 404. FIG. 6 is a pictorial representation of a display screen 600 on which is depicted a registration form 604 for a translator processing node in accordance with the present invention. When a user graphically selects icon 404, a pop-up menu 602 is graphically displayed. If a user wishes to register with the translator service, the usermust select the “Register” option within menu 602. After, the “Register” option is selected, the window 604 is displayed. Within window 604 is depicted a registration form. This registration form is supplied directly by the translator service. The translator service provides the form and determines what-information is included within and requested by the registration form. The user may register with the translator service by completing this registration form. When the user completes and saves this form, the translator service receives and saves the registration information for this user.

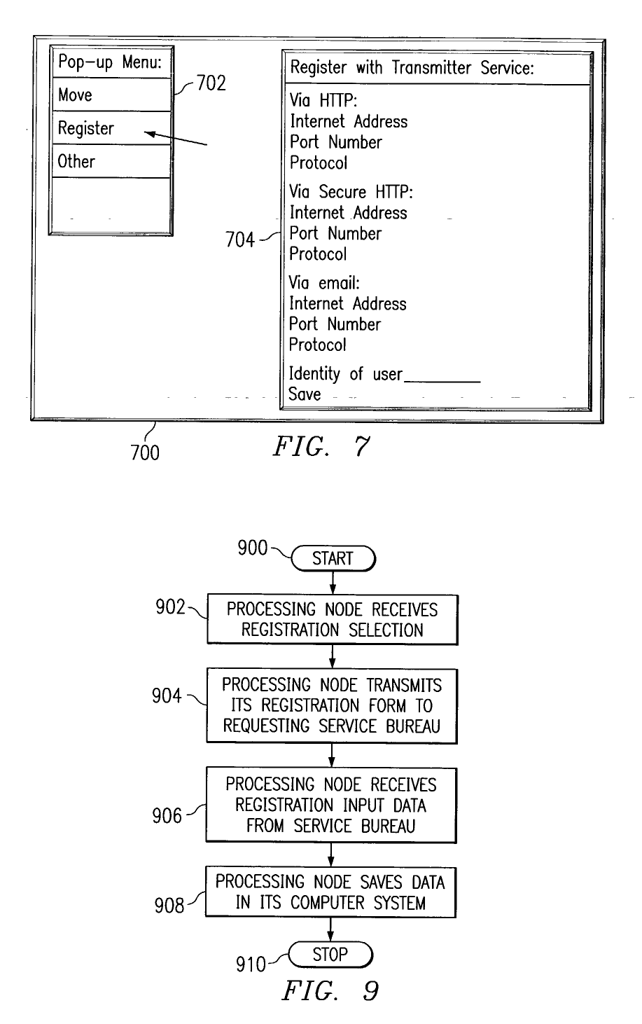

As another example, the user may choose to next register with the transmitter service, depicted by icon 406. FIG. 7 is a pictorial representation of a display screen on which is illustrated a registration form for a transmitter processing node in accordance with the present invention. When icon 406 is selected, a pop-up menu 702 is displayed. If a user wishes to register with the transmitter service, the user must select the “Register” option within menu 702. After, the “Register” option is selected, the window 704 is displayed. Within window 704 is depicted a registration form. This registration form is supplied directly by the transmitter service. The transmitter service provides the form and determines what information is included within and requested by the registration form. The user may register with the transmitter service by completing this registration form. When the user completes and saves this form, the transmitter service receives and saves the registration information for this user.

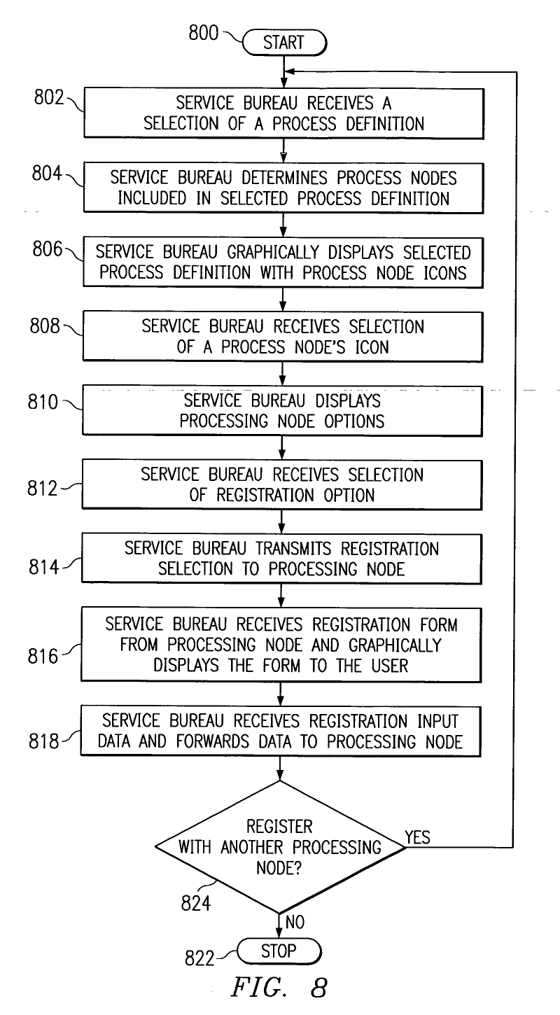

FIG. 8 depicts a high level flow chart which illustrates a service bureau graphically guiding registration with selected processing nodes utilizing a graphically displayed process definition in accordance with the present invention. The process starts as depicted by block 800 and thereafter passes to block 802 which illustrates the service bureau receiving a selection of a process definition. Next, block 804 depicts the service bureau determining which processing nodes are included in the selected process definition. The process then passes to block 806 which illustrates the service bureau graphically displaying the selected process definition along with the iconic representations of the processing nodes included in the process definition.

Block 808, then, depicts the service bureau receiving a graphical selection of an iconic representation of a processing node. Thereafter, block 810 illustrates the service bureau displaying various options associated with the processing node. For example, one option would be to register with the processing node so that the service provided by the processing node may be utilized by the user. The process then passes to block 812 which depicts the service bureau receiving a selection of the registration option. Next, block 814 illustrates the service bureau transmitting the registration selection to the processing node associated with the selected icon.

The process then passes to block 816 which depicts the service bureau receiving a registration form from the processing node. The service bureau then graphically displays the form to the user. Next, block 818 illustrates the service bureau receiving registration input data and forwarding this input data to the processing node.

Those skilled in the art will recognize that when a user selects to register with a service provided by a particular processing node, the user may be routed to that processing node such that the service bureau is no longer involved in the registration process. When this occurs the service bureau does not receive the registration form, receive the registration data, or forward registration data to the processing node. In this case, when the user selects to register with a service, the service bureau routes the user to the processing node which then handles the remaining registration process.

Thereafter, block 820 depicts a determination of whether or not the user wishes to register with another processing node. If a determination is made that the user does wish to register with another processing node, the process passes back to block 802. Referring again to block 820, if a determination is made that the user does not wish to register with another processing node, the process terminates as depicted by block 822.

FIG. 9 illustrates a high level flow chart which depicts a processing node providing a registration form and storing registration information locally in the processing node in accordance with the present invention. The process starts as depicted by block 900 and thereafter passes to block 902 which illustrates a processing node receiving a selection of registration with this processing node. Next, block 904 depicts the processing node transmitting its registration form to the requesting service bureau. The process then passes to block 906 which illustrates the processing node receiving registration data from the service bureau. Thereafter, block 908 depicts the processing node saving this registration input data in its computer system. The process then terminates as illustrated by block 910.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for registering with a service, said method comprising the steps of:
generating a process definition, said process definition including a particular sequence of selected ones of a plurality of services provided by a plurality of processing nodes;
graphically depicting said process definition;
permitting a graphical selection of any one of said plurality of processing nodes utilizing said graphical depiction;
in response to a receipt of a selection of one of said plurality of processing nodes, providing, by said one of said plurality of processing nodes, a registration form; and
receiving, by said one of said plurality of processing nodes, registration information through said registration form, wherein said registration is completed directly with said one of said plurality of processing nodes.

2. The method according to claim 1, further comprising the steps of:
providing a service bureau;
graphically depicting said process definition utilizing said service bureau;
permitting, by said service bureau, a graphical selection of any one of said plurality of processing nodes utilizing said graphical depiction; and
wherein a user is permitted to register directly with said one of said plurality of processing nodes.

3. The method according to claim 1, further comprising the step of:
determining by said one of said processing nodes user-profile information that is needed in order to register with said one of said processing nodes.

4. The method according to claim 3, further comprising the step of:
including questions in said registration form designed to obtain said user-profile information.

5. The method according to claim 1, further comprising the steps of:
receiving a selection of a second one of said plurality of processing nodes;
providing a second registration form by said second one of said plurality of processing nodes; and
receiving, within said second one of said plurality of processing nodes, second registration information through said second registration form.

6. The method according to claim 1, wherein each of said processing nodes is provided by different, unrelated business entities.

7. The method according to claim 1, further comprising the step of:
graphically depicting said process definition by depicting each one of said selected ones of said plurality of services in said particular sequence utilizing an iconic representation of said each one of said selected ones of said plurality of services.

8. The method according to claim 1, further comprising the step of:
simultaneously depicting each one of said selected ones of said plurality of services utilizing a single display screen.

9. The method according to claim 1, further comprising the step of:
providing a service bureau;
providing a second plurality of services;
said second plurality of services being provided by a second plurality of processing nodes;
said plurality of services being included within said second plurality of services, and said plurality of nodes being included within said second plurality of nodes;
graphically presenting said second plurality of services to a user by said service bureau utilizing a single display screen; and
permitting a user to graphically select said selected ones of said plurality of services in said particular sequence from said second plurality of services.

10. The method according to claim 9, further comprising the step of:
adding a new service to said second plurality of services without affecting a prior registration with any one of said plurality of services.

11. A data processing system for registering with a service, comprising:
a process definition, said process definition including a particular sequence of selected ones of a plurality of services provided by a plurality of processing nodes;
said system including a CPU executing code for graphically depicting said process definition;
said CPU executing code for permitting a graphical selection of any one of said plurality of processing nodes utilizing said graphical depiction;
in response to a receipt of a selection of one of said plurality of processing nodes, said one of said plurality of processing nodes providing a registration form; and
said one of said plurality of processing nodes receiving registration information through said registration form, wherein said registration is completed directly with said one of said plurality of processing nodes.

12. The system according to claim 11, further comprising:
a service bureau;
said service bureau graphically depicting said process definition;
said service bureau permitting a graphical selection of any one of said plurality of processing nodes utilizing said graphical depiction; and
wherein a user is permitted to register directly with said one of said plurality of processing nodes.

13. The system according to claim 11, further comprising:
said one of said processing nodes determining user-profile information that is needed in order to register with said one of said processing nodes.

14. The system according to claim 13, further comprising:
said registration form including questions designed to obtain said user-profile information.

15. The system according to claim 11, further comprising:
a selection of a second one of said plurality of processing nodes being received;
a second registration form being provided by said second one of said plurality of processing nodes; and
said second one of said plurality of processing nodes receiving second registration information through said second registration form.

16. The system according to claim 11, wherein each of said processing nodes is provided by different, unrelated business entities.

17. The system according to claim 11, further comprising:
said CPU executing code for graphically depicting said process definition by depicting each one of said selected ones of said plurality of services in said particular sequence utilizing an iconic representation of said each one of said selected ones of said plurality of services.

18. The system according to claim 11, further comprising:
a display screen for simultaneously depicting each one of said selected ones of said plurality of services.

19. The system according to claim 11, further comprising:
a service bureau;
a second plurality of services;
said second plurality of services being provided by a second plurality of processing nodes;
said plurality of services being included within said second plurality of services, and said plurality of nodes being included within said second plurality of nodes;
said CPU executing code for graphically presenting said second plurality of services to a user by said service bureau utilizing a single display screen; and
said CPU executing code for permitting a user to graphically select said selected ones of said plurality of services in said particular sequence from said second plurality of services.

20. The system according to claim 19, further comprising:
a new service being added to said second plurality of services without affecting a prior registration with any one of said plurality of services.

21. A computer program product in a data processing system for registering with a service, said product comprising:
instruction means for generating a process definition, said process definition including a particular sequence of selected ones of a plurality of services provided by a plurality of processing nodes;
instruction means for graphically depicting said process definition;
instruction means for permitting a graphical selection of any one of said plurality of processing nodes utilizing said graphical depiction;
in response to a receipt of a selection of one of said plurality of processing nodes, instruction means for providing, by said one of said plurality of processing nodes, a registration form; and
instruction means for receiving, by said one of said plurality of processing nodes, registration information through said registration form, wherein said registration is completed directly with said one of said plurality of processing nodes.

22. The product according to claim 21, further comprising:
instruction means for providing a service bureau;
instruction means for graphically depicting said process definition utilizing said service bureau;
instruction means for permitting, by said service bureau, a graphical selection of any one of said plurality of processing nodes utilizing said graphical depiction; and
wherein a user is permitted to register directly with said one of said plurality of processing nodes.

23. The product according to claim 21, further comprising:
instruction means for determining by said one of said processing nodes user-profile information that is needed in order to register with said one of said processing nodes.

24. The product according to claim 23, further comprising:
instruction means for including questions in said registration form designed to obtain said user-profile information.

25. The product according to claim 21, further comprising:
instruction means for receiving a selection of a second one of said plurality of processing nodes;
instruction means for providing a second registration form by said second one of said plurality of processing nodes; and
instruction means for receiving, within said second one of said plurality of processing nodes, second registration information through said second registration form.

26. The product according to claim 21, wherein each of said processing nodes is provided by different, unrelated business entities.

27. The product according to claim 21, further comprising:
instruction means for graphically depicting said process definition by depicting each one of said selected ones of said plurality of services in said particular sequence utilizing an iconic representation of said each one of said selected ones of said plurality of services.

28. The product according to claim 21, further comprising:
instruction means for simultaneously depicting each one of said selected ones of said plurality of services utilizing a single display screen.

29. The product according to claim 21, further comprising:
instruction means for providing a service bureau;
instruction means for providing a second plurality of services;
said second plurality of services being provided by a second plurality of processing nodes;
said plurality of services being included within said second plurality of services, and said plurality of nodes being included within said second plurality of nodes;
instruction means for graphically presenting said second plurality of services to a user by said service bureau utilizing a single display screen; and
instruction means for permitting a user to graphically select said selected ones of said plurality of services in said particular sequence from said second plurality of services.

30. The product according to claim 29, further comprising:
instruction means for adding a new service to said second plurality of services without affecting a prior registration with any one of said plurality of services.
